(19) United States
(12) Patent Application Publication
(10) Pub. No.: US 2012/0182986 A1
(43) Pub. Date: Jul. 19, 2012

(54) Timing Control

(76) Inventor: Benoist Pierre Sebire, Tokyo (JP)

(21) Appl. No.: 13/498,948

(22) PCT Filed: Oct. 2, 2009
(86) PCT No.: PCT/EP2009/062797

§ 371 Date: Mar. 29, 2012

(51) Int. Cl. H04W 56/00

(52) U.S. Cl. 370/343

(57) ABSTRACT

A method including at a first device configured for making one or more transmissions to a second device in one or more of a plurality of frequency blocks and configured to receive respective timing commands for each of said plurality of frequency blocks: determining that the most recently received timing commands for each of the plurality of frequency blocks are all valid, when a predetermined period of time has not expired since receiving the most recent timing command for any one of said plurality of frequency blocks.

The present invention relates to controlling the timing of a radio transmission in a communication system. In particular, it relates to receiving timing control data from a node to which a radio transmission is made, and determining whether a device has the necessary timing information for a transmission to said node.

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems. A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access systems include Universal Terrestrial Radio Access Networks (UTRAN), evolved EUTRAN (EUTRAN) and GSM (Global System for Mobile) EDGE (Enhanced Data for GSM Evolution) Radio Access Networks (GERAN).

In order to compensate for the variation in propagation delays between devices making uplink transmissions to a common base station (eNodeB), and in order to ensure that each device times its uplink transmissions such that they arrive at the base station at the predetermined times, the base station sends timing advance commands to the devices, which commands indicate the required change of the uplink timing relative to the current uplink timing as a multiple of a predetermined time unit. A timing advance command is considered by the device at which it is received to be valid for a predetermined maximum period of time. When a device receives a timing advance command, it adjusts its uplink transmission timing accordingly, and starts or restarts a time alignment timer, which is configured to expire at a predetermined time unless re-started before then. As long as the time alignment timer is running, the most recently timing advance command is considered to be valid and the device is considered to be time aligned, i.e. considered to have valid timing information for an uplink transmission. If the time alignment timer expires, it is considered that uplink synchronisation is required before the device can make an uplink transmission. The usual procedure is for the device to then initiate what is known as a random access procedure in order to request the base station (eNB) to newly assess the timing adjustment needed at the device.

In the Long Term Evolution (LTE) System Release 8, a device makes an uplink transmission according to a single carrier frequency division multiple access technique. Each uplink transmission is made using a group of orthogonal sub-carriers. Sub-carriers are grouped into units called resource blocks, and a device can make an uplink transmission using groups of resource blocks ranging up to a predetermined maximum number of resource blocks within a predetermined frequency block called a carrier. The bandwidth available for uplink transmissions generally comprises a plurality of carriers; and a device makes an uplink transmission on a selected one of the carriers. A further development of LTE Release 8 (which development is known as LTE-Advanced) provides for carrier aggregation, where two or more carriers are aggregated in order to support transmission bandwidths wider than that defined by a single carrier. In summary, devices operating under LTE Release 8 are served by a single carrier, whereas devices operating under LTE-Advanced can receive or transmit simultaneously on a plurality of carriers. It is deemed desirable for LTE-Advanced to keep the Layer 2 aspects of the hybrid automatic repeat request (HARQ) procedure compliant with Release 8, where this can be achieved without foregoing significant gains. Where a device is scheduled resources spanning a plurality of carriers, it is proposed to have one transport block (or up to two transport blocks in the case that spatial multiplexing is also utilised) and one independent HARQ entity per scheduled carrier. The Medium Access Control layer (MAC layer) generates respective transport blocks for each scheduled carrier, and all possible HARQ repeat transmissions for any transport block take place on the same carrier to which the respective transport block was mapped.

One aim of the present invention is to provide a technique for facilitating the receiving and/or maintenance of separate timing information for each frequency block (such as, for example, a carrier in the system described above) via which a device may make a transmission.

The present invention provides a method comprising: at a first device configured for making one or more transmissions to a second device in one or more of a plurality of frequency blocks and configured to receive respective timing commands for each of said plurality of frequency blocks: determining that the most recently received timing commands for each of the plurality of frequency blocks are all valid, when a predetermined period of time has not expired since receiving the most recent timing command for any one of said plurality of frequency blocks.

The present invention further provides a method comprising: at a first device configured for receiving one or more transmissions from said second device in one or more frequency blocks of a first group of frequency blocks and for making one or more transmissions to a second device in one or more frequency blocks of a second group of frequency blocks: sending timing commands for a plurality of frequency blocks of said first group of frequency blocks to said second device on one frequency block of said second group of frequency blocks. The present invention further provides a method comprising: at a first device configured for sending one or more trans-missions to a second device in one or more frequency blocks of a first group of frequency blocks and receiving one or more transmissions from said second device on one or more frequency blocks of a second group of frequency blocks: receiving respective timing commands for a plurality of frequency blocks of said first group of frequency blocks from said second device on one frequency block of said second group of frequency blocks.

In one embodiment, the method further comprises controlling the timing of one or more transmissions on one or more frequency blocks of said first group of frequency blocks according to one or more of said timing commands.

In one embodiment, said first group of frequency blocks are uplink frequency blocks, and said second group of frequency blocks are downlink frequency blocks.

In one embodiment, timing commands for a plurality of frequency blocks of said first group of frequency blocks are included in a single control data unit.

The present invention further provides a method comprising generating a control data unit including a plurality of timing commands for a plurality of frequency blocks.

In one embodiment, said plurality of timing commands are arranged in said control data unit in a predetermined frequency block order.

In one embodiment, the plurality of timing commands are included in a common control element.

In one embodiment, the plurality of timing commands each comprise a timing advance value.

In one embodiment, said timing commands each comprise a timing advance value and an indication of the frequency block to which said timing advance value relates.

The present invention further provides an apparatus configured to carry out any of the above-described methods.

The present invention further provides apparatus comprising: a processor and memory including computer program code, wherein the memory and the computer program are configured to, with the processor, cause the apparatus at least to perform any of the above-described methods.

The present invention further provides a computer program product comprising program code means which when loaded into a computer controls the computer to perform any of the above-described methods.

The present invention further provides a system comprising: first and second devices; wherein said first device is configured for sending one or more transmissions to said second device in one or more frequency blocks of a first group of frequency blocks; and said second device is configured to send timing commands for a plurality of frequency blocks of said first group of frequency blocks to said first device on one frequency block of a second group of frequency blocks.

Hereunder an embodiment of the present invention will be described, by way of example only, with reference to the following drawings, in which:

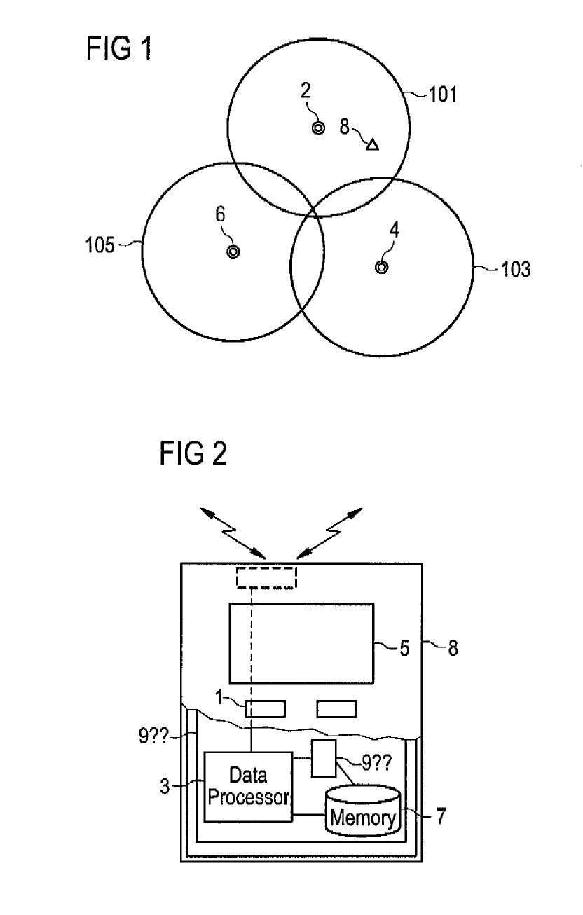

FIG. 1 illustrates a radio access network within which an embodiment of the invention may be implemented, which access network includes a number of cells each served by a respective base station (eNodeB);

FIG. 2 illustrates a user equipment shown in FIG. 1 in further detail.

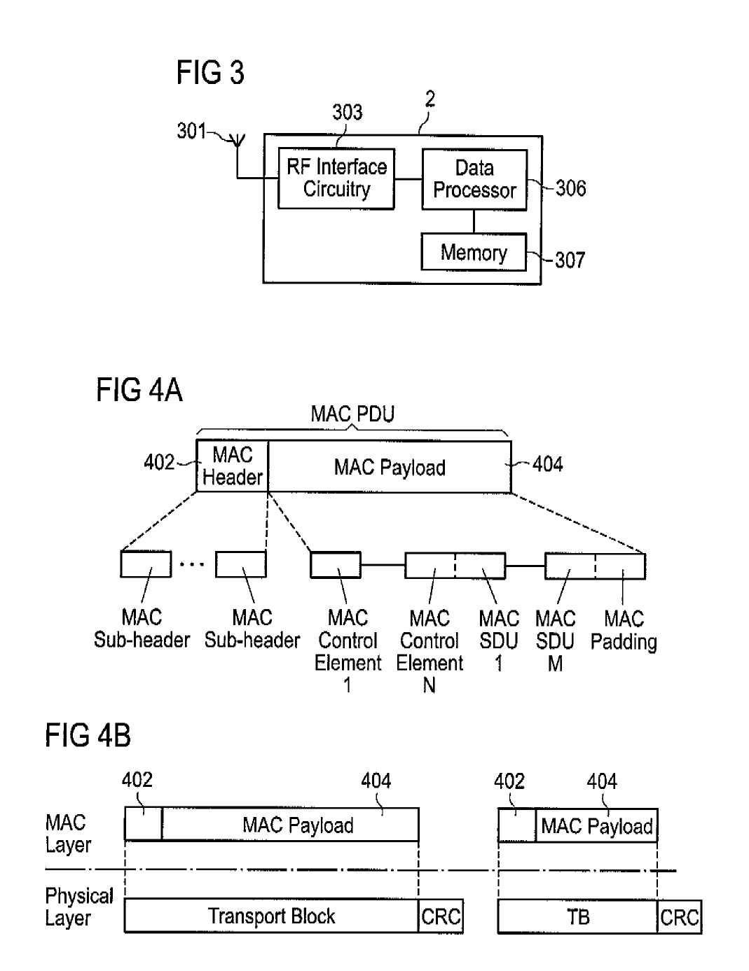

FIG. 3 illustrates an apparatus suitable for implementing an embodiment of the invention at an access node or base station of the radio network shown in FIG. 1;

FIG. 4a illustrates the structure of a MAC PDU unit, and

FIG. 4b illustrates how a MAC PDU unit forms a transport block in the physical layer;

FIG. 5 illustrates an example of a MAC control element for use in a method according to an embodiment of the present invention; and

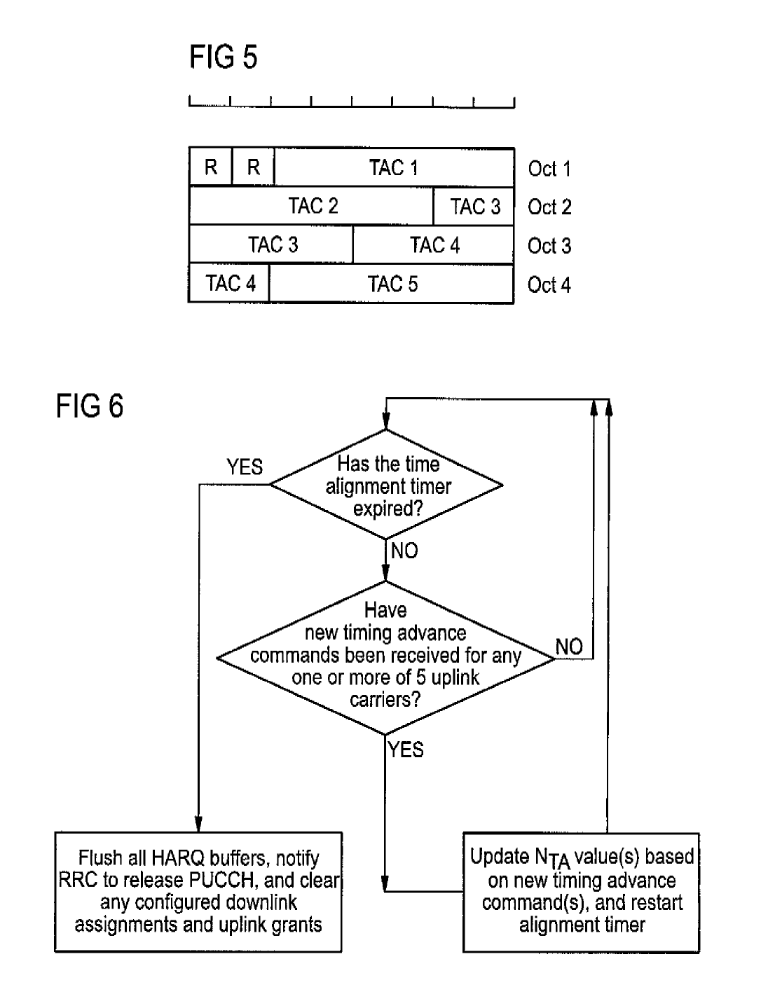

FIG. 6 illustrates an example of an operation of a device in accordance with an embodiment of the present invention.

FIGS. 1, 2 and 3 show respectively the communication system or network, an apparatus for communication within the network, and an access node of the communications network.

FIG. 1 shows a communications system or network comprising a first access node 2 with a first coverage area 101, a second access node 4 with a second coverage area 103 and a third access node 6 with a third coverage area 105. Furthermore FIG. 1 shows user equipment 8 which is configured to communicate with at least one of the access nodes 2, 4, 6. These coverage areas may also be known as cellular coverage areas or cells where the access network is a cellular communications network.

FIG. 2 shows a schematic partially sectioned view of an example of user equipment 8 that may be used for accessing the access nodes and thus the communication system via a wireless interface. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The UE 8 may communicate via an appropriate radio interface arrangement of the UE 8. The interface arrangement may be provided for example by means of a radio part 7 and associated antenna arrangement. The antenna arrangement may be arranged internally or externally to the UE 8.

The UE 8 may be provided with at least one data processing entity 3 and at least one memory or data storage entity 7 for use in tasks it is designed to perform. The data processor 3 and memory 7 may be provided on an appropriate circuit board 9 and/or in chipsets.

The user may control the operation of the UE 8 by means of a suitable user interface such as key pad 1, voice commands, touch sensitive screen or pad, combinations thereof or the like. A display 5, a speaker and a microphone may also be provided. Furthermore, the UE 8 may comprise appropriate connectors (either wired or wireless) to other devices and/or for connecting external accessories, for example hands-free equipment, thereto.

As can be seen with respect to FIG. 1, the UE 8 may be configured to communicate with at least one of a number of access nodes 2, 4, 6, for example when it is located in the coverage area 101 of a first access node 2 the apparatus is configured to be able to communicate to the first access node 2, when in the coverage area 103 of a second node 4 the apparatus may be able to communicate with the second access node 4, and when in the coverage area 105 of the third access node 6 the apparatus may be able to communicate with the third access node 6.

FIG. 3 shows an example of the first access node, which in the embodiment of the invention described below is represented by an evolved node B (eNB) 2. The eNB 2 comprises a radio frequency antenna 301 configured to receive and trans-mit radio frequency signals, radio frequency interface circuitry 303 configured to interface the radio frequency signals received and transmitted by the antenna 301 and the data processor 167. The radio frequency interface circuitry may also be known as a transceiver. The access node (evolved node B) 2 may also comprise a data processor configured to process signals from the radio frequency interface circuitry 303, control the radio frequency interface circuitry 303 to generate suitable RF signals to communicate information to the UE 8 via the wireless communications link. The access node further comprises a memory 307 for storing data, parameters and instructions for use by the data processor 305.

It would be appreciated that both the UE 8 and access node 2 shown in FIGS. 2 and 3 respectively and described above may comprise further elements which are not directly involved with the embodiments of the invention described hereafter.

An embodiment of the present invention is described below, by way of example only, in the context of a LTE (Long Term Evolution) system that employs Single Carrier—Frequency Division Multiple Access (SC-FDMA) for uplink transmissions from the UE 8 to the access node 2.

A portion of the frequency spectrum is reserved for uplink transmissions to the access node 2, and a separate portion of the frequency spectrum is reserved for downlink transmissions from the access node 2. These portions are each divided up into a plurality of frequency blocks (carriers). The UE 8 can make transmissions on one or more of the plurality of carriers that make up the portion reserved for uplink transmissions, and it can receive transmissions on one or more of the plurality of carriers that make up the portion reserved for downlink transmissions. Each carrier is divided up into orthogonal sub-carriers, which can be allocated as radio resources to a transmission in groups thereof. Radio resources (resource blocks defining groups of orthogonal sub-carriers within one or more carriers) are allocated to uplink trans-missions from the UE 8 if data is available to be sent from UE 8. The UE 8 sends buffer status reports (BSRs) to the access node 2 indicating the amount of data in UE 8 to be transmitted on an uplink shared channel (UL-SCH). Depending on the indications in these BSRs from UE 8 and BSRs from other devices served by access node 2, the access node 2 allocates transmission resources to the UE 8, and signals an uplink transmission resource grant message to the UE 8 on a physical downlink control channel (PDCCH).

The resources allocated to UE 8 may include resources within a plurality of the carriers reserved for uplink transmissions. The MAC layer at UE 8 generates a MAC protocol data unit (PDU) for each carrier allocated to UE 8, which PDU forms a respective transport block in the physical layer. Each MAC PDU has a size corresponding to the number of resource blocks allocated to the UE 8 within the respective carrier. Each MAC PDU includes a MAC header 402 and a MAC payload 404 including zero, one or more control elements (CEs) and/or zero, one or more MAC service data units (SDUs). The structure of a MAC PDU and how it becomes the transport block in the physical layer is illustrated in FIGS. 4(a) and 4(b). In FIG. 4(b), CRC is the cyclic redundancy check.

Each transport block is transmitted on its respective carrier at a time controlled according to timing information received for each carrier from access node 2. Timing information for all carriers is received from access node 2 in a single MAC control element included in a single protocol data unit transmitted on one or more of the downlink carriers. An example of the structure of a MAC control element including timing advance commands (TAC) for an example of five uplink carriers is illustrated in FIG. 5. It consists of 4 octets comprising 2 reserved bits R set to “0”, and 30 bits defining five 6-bit timing advance commands (values) for the uplink carriers. The order in which the 6-bit timing advance commands are included in the control element is predetermined and known to both the UE 8 and access node 2, so that the control element does not need to include information about which timing advance command is for which carrier, thereby minimising overhead in the downlink.

The timing advance command control element illustrated in FIG. 5 is incorporated into the payload of a MAC protocol data unit (PDU) at the MAC layer of the access node 2 in the same way as shown for the UE in FIG. 4a. The payload of the MAC PDU may also include one or more other control elements and/or one or more MAC service data units each including data from a respective logical channel. The MAC Header 402 includes a sub-header for each CE and/or SDU included in the payload. Each MAC Subheader consists of a Logical Channel ID (LCID) and optionally a Length (L) field. The LCID indicates whether the corresponding part of the MAC Payload is a MAC Control Element, and if not, to which logical channel the related SDU belongs. The L field indicates the size of the related MAC SDU. Because the number of uplink carriers is known to both UE 8 and access node 2 and therefore the UE 8 can determine the length of the timing advance command control element even without an L-field in the MAC sub-header, the same LCID can be used for the above-described multicarrier timing advance command control element as is currently used for the single carrier timing advance command control element specified in 3GPP 36.321 for LTE Release 8. That LCID is recognised by the UE as indicating that no L-field is used.

Alternatively, according to one variation, the timing advance control element is used with a MAC sub-header that has a new LCID and an L-field indicating the length of the control element. The new LCID would be recognised by the UE 8 as indicating that an L-field is used.

The MAC PDU is transmitted from the access node 2 to UE 8 as a transport block via one of the downlink carriers.

One advantage of including timing advance commands for all the plurality of uplink carriers in a single transport block is that it does not require each downlink carrier to be associated with one and only one uplink carrier, and is therefore of use in situations where there is asymmetric aggregation of carriers (i.e. in situations where downlink transmissions and uplink transmissions are made using a different number of carriers).

As specified in 3GPP TS 36.213 V8.7.0 (2009-05), each 6-bit timing advance command indicates the index value T_{A} (0, 1, 2 . . . 63) used to control the amount of timing adjustment that UE has to apply for the respective carrier. In more detail, T_{A} indicates adjustment of the current N_{TA} value, N_{TA,old}, to the new N_{TA} value, N_{TA,new}, by index values of T_{A}=0, 1, 2, . . . , 63, where N_{TA,new}=N_{TA,old}+(T_{A}−31)×16. Here, adjustment of N_{TA} value by a positive or a negative amount indicates advancing or delaying the uplink transmission timing by a given amount respectively. As specified in 3GPP TS 36.211 V8.7.0 (2009-05), the N_{TA} value is the timing offset between uplink and downlink radio frames at UE 8, expressed in basic time units Tₛ.

For a timing advance command received on subframe n, the corresponding adjustment of the timing shall apply from the beginning of subframe n+6. When the UE's uplink transmissions in subframe n and subframe n+1 are overlapped due to the timing adjustment, the UE shall transmit complete subframe n and not transmit the overlapped part of subframe n+1.

The timing advance commands are valid for a predetermined maximum period of time, before the expiry of which they need to be replaced by new timing advance commands. A single time alignment timer is used to control how long UE 8 is considered to be uplink time aligned for a transmission on any of the uplink carriers. The time alignment timer is started or restarted each time the UE receives a timing advance control element, such as the multicarrier timing advance control element as described above. For as long as the time alignment timer is running, UE 8 is considered to be uplink time aligned for all uplink carriers. If the time alignment timer expires, UE 8 does the following: (a) flushes all HARQ buffers, (b) notifies radio resource control (RRC) to release the physical uplink control channel, and (c) clears any configured assignments of downlink resources or grants of uplink resources.

In another embodiment of the present invention, UE 8 receives timing advance commands for each of the carriers in separate control elements, either in the same transport block or different transport blocks of the same downlink carrier. Each timing advance command control element includes a timing advance command for only one of the plurality of uplink carriers. As well as the index value T_{A} described above, the control element also includes one of a plurality of predetermined values by which the UE 8 can identify which of the uplink carriers the index value T_{A} relates to. This alternative technique of including timing advance commands for all the plurality of uplink carriers in a single downlink carrier also has the advantage that it does not require each downlink carrier to be associated with one and only one uplink carrier, and is therefore of use in situations where there is asymmetric aggregation of carriers (i.e. in situations where downlink transmissions and uplink transmissions are made using a different number of carriers).

A single time alignment timer is also used for this alternative technique. Where UE 8 has received timing advance commands for each of the uplink carriers, the UE 8 restarts the single time alignment timer whenever it receives a timing advance command from the access node 2 for any of the uplink carriers. Whilst the single time alignment timer is running (i.e. has not expired), the UE 8 is configured to consider that it has valid timing information for making a transmission to the access node 2 on any of the uplink carriers. This technique is illustrated in the flow chart of FIG. 7. Using a single alignment timer for all uplink carriers has the advantage that it avoids the complications that would otherwise arise at the MAC layer from the necessity to deal with separate time alignment timers expiring at different times (i.e. asynchronous TA timer expiry).

In the above-described embodiments, one example for a carrier size is 20 MHz, and one example for the number of uplink carriers is five. The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountaro View, Calif. and Cadence Design, of San Jose, Califormia automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication. In addition to the modifications explicitly mentioned above, it will be evident to a person skilled in the art that various other modifications of the described embodiment may be made within the scope of the invention.

1. A method comprising: at a first device configured for making one or more transmissions to a second device in one or more of a plurality of frequency blocks and configured to receive respective timing commands for each of said plurality of frequency blocks: determining that the most recently received timing commands for each of the plurality of frequency blocks are all valid, when a predetermined period of time has not expired since receiving the most recent timing command for any one of said plurality of frequency blocks.

2. A method comprising: at a first device configured for receiving one or more transmissions from said second device in one or more frequency blocks of a first group of frequency blocks and for making one or more transmissions to a second device in one or more frequency blocks of a second group of frequency blocks: sending timing commands for a plurality of frequency blocks of said first group of frequency blocks to said second device on one frequency block of said second group of frequency blocks.

3. A method comprising: at a first device configured for sending one or more transmissions to a second device in one or more frequency blocks of a first group of frequency blocks and receiving one or more transmissions from said second device on one or more frequency blocks of a second group of frequency blocks: receiving respective timing commands for a plurality of frequency blocks of said first group of frequency blocks from said second device on one frequency block of said second group of frequency blocks.

4. A method according to claim 3, further comprising controlling the timing of one or more transmissions on one or more frequency blocks of said first group of frequency blocks according to one or more of said timing commands.

5. A method according to claim 2, wherein said first group of frequency blocks are uplink frequency blocks, and said second group of frequency blocks are downlink frequency blocks.

6. A method according to claim 2, wherein timing commands for a plurality of frequency blocks of said first group of frequency blocks are included in a single control data unit.

7. A method, comprising generating a control data unit including a plurality of timing commands for a plurality of frequency blocks.

8. A method according to claim 6 wherein said plurality of timing commands are arranged in said control data unit in a predetermined frequency block order.

9. A method according to claim 6, wherein the plurality of timing commands are included in a common control element.

10. A method according to claim 6, wherein the plurality of timing commands each comprise a timing advance value.

11. A method according to claim 2, wherein said timing commands each comprise a timing advance value and an indication of the frequency block to which said timing advance value relates.

12. An apparatus configured to carry out the method of claim 1.

13. An apparatus comprising: a processor and memory including computer program code, wherein the memory and the computer program are configured to, with the processor, cause the apparatus at least to perform the method of claim 1.

14. A computer program product comprising program code means which when loaded into a computer controls the computer to perform a method according to claim 1.

15. A system comprising: first and second devices; wherein said first device is configured for sending one or more transmissions to said second device in one or more frequency blocks of a first group of frequency blocks; and said second device is configured to send timing commands for a plurality of frequency blocks of said first group of frequency blocks to said first device on one frequency block of a second group of frequency blocks.
